(19) United States
(12) Patent Application Publication
(10) Pub. No.: US 2020/0049060 A1
(43) Pub. Date: Feb. 13, 2020

(54) ENGINE SYSTEM AND METHOD OF CONTROLLING A TURBOCHARGER AND TURBOCHARGER OF AN ENGINE SYSTEM

(71) Applicant: GM Global Technology Operations LLC, Detroit, MI (US)

(72) Inventors: Francesco Acquaviva, Turin (IT); Roberto Romanato, Settimo Torinese (IT)

(21) Appl. No.: 16/102,173

(22) Filed: Aug. 13, 2018

(51) Int. Cl. F02B 37/22; F02B 37/24; F02D 41/00

(52) U.S. Cl. CPC F02B 37/22; F02B 37/24; F02D 2200/0406; F05D 2220/40; F02D 41/0007

(57) ABSTRACT

An engine system includes an internal combustion engine including an intake manifold having an inlet, variable geometry turbocharger (VGT) including a mechanical compressor having a mechanical compressor outlet fluidically connected to the intake manifold and a turbine, and an electric compressor including an electric compressor outlet fluidically connected to the intake manifold. A first sensor is arranged to detect a first fluid pressure value at the mechanical compressor outlet. A second sensor is arranged to detect a second fluid pressure value at the inlet of the intake manifold. A controller is operatively connected to first sensor and the second sensor. The controller is operable to adjust operation of at least one of the VGT and the electric compressor when one of the first fluid pressure value and the second fluid pressure value reaches a selected value.

### INTRODUCTION

The subject disclosure relates to the art of turbocharged systems and, more particularly, to a method of controlling a turbocharger.

Current turbocharged vehicles may include a mechanical compressor and an electric compressor. The electric compressor spools up, e.g., gets to a desired speed, faster than the mechanical compressor. As such, the electric compressor may be activated during an initial start-up or warm up phase of motor operation. Once the mechanical compressor is capable of meeting selected boost pressure set point requirements, the electric compressor may be deactivated.

Conflicts may arise between control of variable geometry turbochargers (VGT) and the electric compressor. The VGT may shift in response to the electric compressor slowing after deactivation. During such times, the electric compressor may be reactivated. In addition, operation of the electric compressor may result in a boost pressure overshoot that could take time to correct. Additional activations of the electric compressor may lead to an increase in CO2 generation and component stress. Overshoot imposes a penalty on air system performance. Accordingly, it is desirable to provide a control system that reduces electric compressor activation events and instances of boost pressure overshoot.

### SUMMARY

In accordance with an exemplary embodiment, an engine system includes an internal combustion engine including an intake manifold having an inlet, variable geometry turbocharger (VGT) including a mechanical compressor having a mechanical compressor outlet fluidically connected to the intake manifold and a turbine, and an electric compressor including an electric compressor outlet fluidically connected to the intake manifold. A first sensor is arranged to detect a first fluid pressure value at the mechanical compressor outlet. A second sensor is arranged to detect a second fluid pressure value at the inlet of the intake manifold. A controller is operatively connected to first sensor and the second sensor. The controller is operable to adjust operation of at least one of the VGT and the electric compressor when one of the first fluid pressure value and the second fluid pressure value reaches a selected value.

In addition to one or more of the features described herein the controller adjusts the VGT when a minimum of the first fluid pressure value and the second fluid pressure value corresponds to the selected value.

In addition to one or more of the features described herein the controller includes a non-volatile memory having stored thereon the selected value.

In addition to one or more of the features described herein a closed loop control system is operatively connected to the VGT, wherein the selected value corresponds to a proxy feedback to the closed loop control system.

In addition to one or more of the features described herein the electric compressor includes an electric compressor inlet fluidically connected to the mechanical compressor outlet.

In addition to one or more of the features described herein the first sensor is arranged at the electric compressor inlet.

In addition to one or more of the features described herein a closed loop control system is operatively connected to the electric compressor.

In accordance with another exemplary embodiment, a method of adjusting variable geometry turbocharger (VGT) including a mechanical compressor includes detecting a first fluid pressure value at an outlet of the mechanical compressor, sensing a second fluid pressure value at an inlet of an intake manifold fluidically connected to the mechanical compressor, activating an electric compressor fluidically connected to the intake manifold, and controlling at least one of a geometry of the VGT and operation of the electric compressor when one of the first fluid pressure and the second fluid pressure reaches a selected value.

In addition to one or more of the features described herein controlling the VGT includes detecting a minimum of the first fluid pressure value and the second fluid pressure value.

In addition to one or more of the features described herein the minimum of the first fluid pressure value and the second fluid pressure value represents a proxy feedback to a VGT controller.

In addition to one or more of the features described herein include sending the proxy feedback to a closed loop control system of the VGT controller.

In addition to one or more of the features described herein activating the electric compressor including passing a single through a closed loop feedback system operatively connected to the electric compressor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a schematic diagram illustrating an internal combustion engine system including a mechanical turbocharger, an electrical turbocharger, and a turbocharger control system, in accordance with an exemplary aspect; and

FIG. 2 is a block diagram depicting the turbocharger control system, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

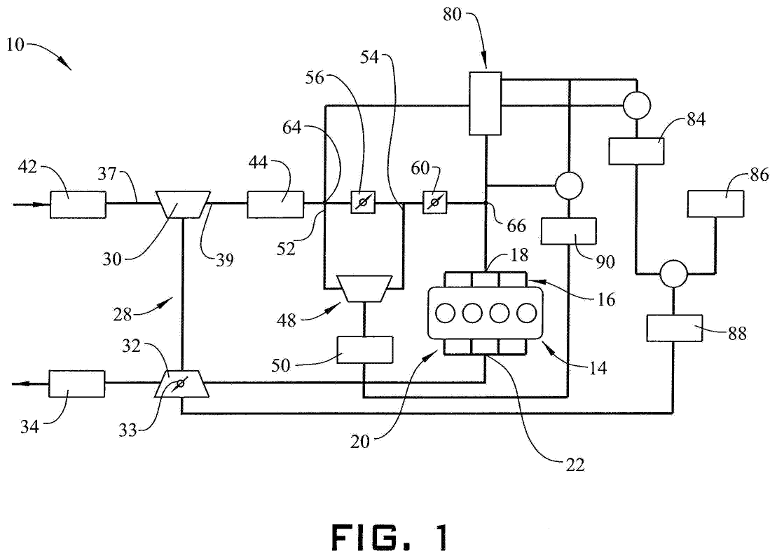

Referring to FIG. 1, an internal combustion engine system, in accordance with an exemplary embodiment, is indicated generally at 10. Engine system 10 includes an internal combustion engine 14 including an intake manifold 16 having an inlet 18 and an exhaust manifold 20 having an outlet 22. Engine system 10 includes a variable geometry turbocharger (VGT) 28 fluidically connected to internal combustion engine 14. VGT 28 includes a mechanical compressor 30 operatively connected to a turbine 32. Turbine 32 includes selectively positionable guide vanes 33 that adjusts a geometry of VGT 28. Turbine 32 is fluidically connected to outlet 22 and an exhaust after treatment system 34. Exhaust gases from internal combustion engine 14 drive turbine 32 which, in turn, drives mechanical compressor 20.

Mechanical compressor 30 includes an intake 37 and a compressor outlet 39. Intake 37 is fluidically connected to an air filter system 42. Compressor outlet 39 is fluidically connected to a charge air cooler (CAC) 44. An electric compressor (eCompressor) 48 is fluidically connected to, and downstream of, mechanical compressor 30. eCompressor 48 is driven by an electric motor 50. eCompressor 48 includes an eCompressor inlet 52 and an eCompressor outlet 54. A bypass valve 56 is connected between eCompressor inlet 52 and eCompressor outlet 54. Bypass valve 56 may selectively fluidically disconnect eCompressor 48 from internal combustion engine 14. eCompressor 48 may be operated at an initial start-up phase of operation of internal combustion engine 10 to supplement air supply to intake manifold 16 as mechanical compressor 30 spools up to operational speed. A throttle body 60 is connected to intake manifold 16 downstream of eCompressor outlet 54.

In one embodiment, a first sensor 64 is arranged downstream of CAC 44 at eCompressor inlet 52. The particular location of first sensor 64 may vary between compressor outlet 39 and eCompressor inlet 52. First sensor 64 takes the form of a first pressure sensor (not separately labeled) that detects a fluid pressure value of the fluid passing from mechanical compressor 30. A second sensor 66 is arranged to detect fluid pressure downstream of eCompressor 48. In accordance with an exemplary aspect, second sensor 66 is arranged in inlet 18 of intake manifold 16. The particular location of second sensor 66 may vary. Second sensor 66 takes the form of a second fluid pressure sensor (also not separately labeled) that detects a second fluid pressure value of fluid passing into intake manifold 16.

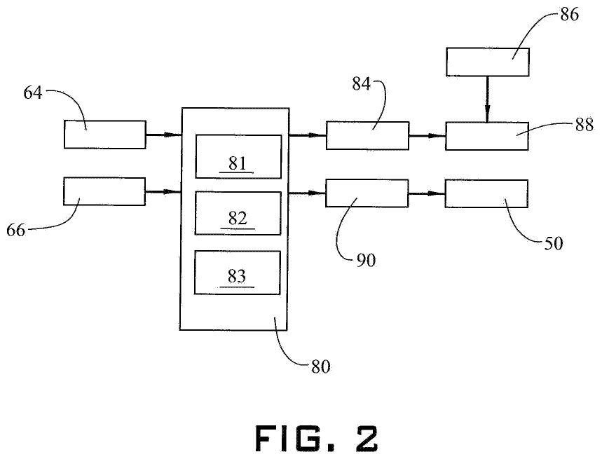

Referring to FIG. 2 and with continued reference to FIG. 1, engine system 10 also includes a controller 80 having a central processor unit 81, a non-volatile memory module 82 and a VGT control module 83. In an embodiment, CPU 81 may be replaced by a general processor unit (GPU). Non-volatile memory 82 stores a boost pressure set point value used to control VGT 28 and/or eCompressor 48. Controller 80 is operatively connected to a closed loop VGT circuit 84 and an open loop VGT circuit 86. Open loop VGT circuit 86 may receive inputs from a fuel injector system (not shown) and engine speed sensors (also not shown). Closed loop VGT circuit 84 and open loop VGT circuit 86 are operatively connected to a VGT control actuator 88. VGT actuator 88 may selectively control a position of guide vanes 33 to adjust a geometry of VGT 28. Controller 80 is also connected to a closed loop eCompressor circuit 90 which is operatively connected to electric motor 50.

In accordance with an exemplary embodiment, controller 80 receives at VGT module 83 signals from first sensor 64 and second sensor 66. Controller 80 determines a “min P” from one of first sensor 64 and second sensor 66. The min P is provided as a proxy feedback to closed loop VGT circuit 84. Controller 80 also provides a boost pressure set point to closed loop VGT circuit 84. When the min P reaches a selected value, which may depend on various parameters of engines system 10, controller 80 may adjust a parameter of VGT 28, such as a position of guide vanes 33, through closed loop VGT circuit 84.

With the min P, controller 80 receives a pressure upstream of eCompressor 48 while eCompressor 48 is in operation. In this manner, any effect that eCompressor 48 may provide on VGT circuit 84 may be hidden from controller 80. In this manner, VGT circuit 84 may control mechanical compressor 30 as if eCompressor 48 is not present so as to increase performance of internal combustion engine 14. In an embodiment, when bypass valve is open or eCompressor 48 is operating at idle speed or idle power, min P releases intake manifold pressure (e.g., pressure provided by mechanical compressor 30 and eCompressor 48) in order to ostensibly satisfy boost pressure only with mechanical turbine 30.

Closed loop eCompressor circuit 90 receives a pressure signal from second sensor 66. The pressure signal from second sensor 66 is compared with a boost pressure set point stored in non-volatile memory 82. When the pressure signal from second sensor 66 reaches the boost pressure set point, controller 80 may deactivate eCompressor 48 through closed loop eCompressor circuit 90. With this arrangement, control of VGT 30 may be decoupled from operation of eCompressor 48. By decoupling or hiding flow effects established by eCompressor 48, VGT turbine 30 may be adjusted to reduce boost point pressure overshoot and undershoot thereby reducing air system response time to eCompressor operation while internal combustion engine 14 comes up to operating temperatures and speed.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An engine system comprising:
an internal combustion engine including an intake manifold having an inlet;
a variable geometry turbocharger (VGT) including a mechanical compressor having a mechanical compressor outlet fluidically connected to the intake manifold and a turbine;
an electric compressor including an electric compressor outlet fluidically connected to the intake manifold;
a first sensor arranged to detect a first fluid pressure value at the mechanical compressor outlet;
a second sensor arranged to detect a second fluid pressure value at the inlet of the intake manifold; and
a controller operatively connected to the first sensor and the second sensor, the controller being operable to adjust operation of at least one of the VGT and the electric compressor when one of the first fluid pressure value and the second fluid pressure value reaches a selected value.

2. The engine system according to claim 1, wherein the controller adjusts the VGT when a minimum of the first fluid pressure value and the second fluid pressure value corresponds to the selected value.

3. The engine system according to claim 2, wherein the controller includes a non-volatile memory having stored thereon the selected value.

4. The engine system according to claim 2, further comprising: a closed loop control system operatively connected to the VGT, wherein the selected value corresponds to a proxy feedback to the closed loop control system.

5. The engine system according to claim 1, wherein the electric compressor includes an electric compressor inlet fluidically connected to the mechanical compressor outlet.

6. The engine system according to claim 5, wherein the first sensor is arranged at the electric compressor inlet.

7. The engine system according to claim 1, further comprising a closed loop control system operatively connected to the electric compressor.

8. A method of adjusting variable geometry turbocharger (VGT) including a mechanical compressor comprising:
detecting a first fluid pressure value at an outlet of the mechanical compressor;
sensing a second fluid pressure value at an inlet of an intake manifold fluidically connected to the mechanical compressor;
activating an electric compressor fluidically connected to the intake manifold; and
controlling at least one of a geometry of the VGT and operation of the electric compressor when one of the first fluid pressure value and the second fluid pressure value reaches a selected value.

9. The method of claim 8, wherein controlling the VGT includes detecting a minimum of the first fluid pressure value and the second fluid pressure value.

10. The method of claim 9, wherein the minimum of the first fluid pressure value and the second fluid pressure value represents a proxy feedback to a VGT controller.

11. The method of claim 10, further comprising: sending the proxy feedback to a closed loop control system of the VGT controller.

12. The method of claim 8, wherein activating the electric compressor including passing a single through a closed loop feedback system operatively connected to the electric compressor.
